(19) United States
(12) Patent Application Publication
(10) Pub. No.: US 2023/0163487 A1
(43) Pub. Date: May 25, 2023

(54) SLOT ANTENNAS WITH BRIDGE PORTIONS

(71) Applicant: Hewlett-Packard Development Company, L.P., Spring, TX (US)

(72) Inventors: Chin-Hung Ma, Taipei (TW); Pai Cheng Huang, Taipei (TW); Po Chao Chen, Taipei (TW)

(21) Appl. No.: 17/535,600

(22) Filed: Nov. 25, 2021

(51) Int. Cl. H01Q 21/06; H01Q 13/10; H01Q 21/00

(52) U.S. Cl. CPC H01Q 21/064; H01Q 13/106; H01Q 21/0043

(57) ABSTRACT

In an example, an electronic device includes a conductive housing. The conductive housing may include a first slot, a second slot, and a bridge portion to separate the first slot and the second slot. Further, the electronic device may include an antenna layout disposed across the first slot, the second slot, and the bridge portion. Furthermore, the electronic device may include an antenna feed coupled to the antenna layout in the first slot and an antenna ground coupled to the antenna layout in the second slot.

### BACKGROUND

Portable electronic devices are becoming increasingly popular. Examples of portable electronic devices may include handheld computers (e.g., notebooks, tablets, and the like), cellular telephones, media players, and hybrid devices which include the functionality of multiple devices of this type. Due in part to their mobile nature, such electronic devices may often be provided with wireless communications capabilities, which may rely on antenna technology to radiate radio frequency (RF) signals for transmission as well as to gather RF broadcast signals for reception.

### BRIEF DESCRIPTION OF THE DRAWINGS

Examples are described in the following detailed description and in reference to the drawings, in which:

FIG. 1A is a schematic diagram of an example electronic device, including an antenna layout disposed across a first slot, a second slot, and a bridge portion;

FIG. 1B is a schematic diagram of the example electronic device of FIG. 1A, depicting additional features;

FIG. 2 is a schematic diagram of another example electronic device, depicting an antenna trace disposed on a printed circuit board (PCB) and extended from a first slot to a second slot via a bridge portion;

FIG. 3A is a cross-sectional front view of a portion of the example electronic device of FIG. 2, depicting additional features;

FIG. 3B is a cross-sectional side view of the example electronic device of FIG. 2, depicting a microstrip line structure;

FIG. 3C is another cross-sectional side view of the example electronic device of FIG. 2, depicting the first slot under the antenna trace.

FIG. 4A is a schematic diagram of an example electronic device, depicting a PCB antenna to couple an electromagnetic energy to a first closed slot, a second closed slot, and a bridge portion; and

FIG. 4B is a schematic diagram of the example electronic device of FIG. 4A, depicting additional features.

### DETAILED DESCRIPTION

As mobile computing infrastructure evolves to enable electronic devices to transmit and receive significant amount of data while on the move, the abilities of the electronic devices to receive and transmit various signals simultaneously increase in demand. For example, the electronic devices may be notebooks, tablets, cellular telephones, media players, and hybrid devices which include the functionality of multiple devices of this type. Further, the electronic devices may employ radio devices for communication via wireless links operating on a variety of radio access technologies. For example, an electronic device may employ a radio device for wireless local area network (WLAN) signals, or the like. Example WLAN signals may include wireless links adhering to standards such as, for example, wireless fidelity (Wi-Fi), wireless gigabit alliance (WiGig), and/or wireless personal area network (WPAN). In other examples, several radio devices may be available for each radio access technology to enable aggregated data communications such as via plural multiple in, multiple out (MIMO) streams to enhance bandwidth or reliability.

Such electronic devices may include antennas to communicate with the wireless network. An antenna may be a device that emits or receives radio waves. The antenna may be used with a transmitter of a radio device. The transmitter may generate a radio signal, which may be an alternating current. The antenna may emit the radio signal as electromagnetic energy termed radio waves. The antenna may also be used with a receiver of the radio device. The receiver may receive a radio signal from the antenna and convert the information carried by the radio signal into a usable form. The radio device including both the transmitter and the receiver may be termed as a transceiver. For example, the electronic device may include a WLAN antenna to communicate with a local area network (LAN), or the like. Other example antennas may include a WWAN antenna to communicate with a wide area network (WAN), cellular antennas, wireless fidelity (Wi-Fi) antennas, Bluetooth antennas, global navigation satellite system (GNSS) antennas, and/or near field communication (NFC) antennas.

Such electronic devices may be provided with a conductive housing (e.g., a rear housing that houses a display panel). The conductive housing may be formed from a metal. In such electronic devices, the presence of the conductive housing can influence the antenna performance. The antenna performance may be degraded when the conductive housing interferes with the antenna operation. To reduce the interference, the antennas for the electronic devices may be formed as slot antennas.

A slot antenna may be formed from portions of the conductive housing. In an example, the slot antenna is formed from a slot in the conductive housing. For example, the slot antenna is formed from a closed slot and an antenna structure (e.g., a printed circuit board (PCB) with an antenna trace, a dielectric material with a conductive pattern, or the like) of the electronic device. Such antennas can be used for the WLAN communications.

Further, a width of the slot may have an impact on the performance of the slot antenna. For example, consider that a closed loop slot antenna is disposed in the electronic device. The closed loop slot antenna may be formed by a closed slot in the conductive housing of the electronic device. In this example, the slot, which is a non-metal area, is defined for radiation of the antenna. The slot may have a dimension of around half wavelength to quarter wavelength of an application frequency. In such a scenario, the antenna radiation performance may be around 50% when a width of the slot is around 2.5 mm for the 2.4 GHz, 5 GHz, and 6 GHz applications (e.g., designed for WiFi, WiFi 6E, or the like applications) without considering an insertion loss of a coaxial cable (e.g., which connects to the slot antenna via an antenna feed). In this example, the antenna structure may be defined as an “antenna feed” and an “antenna ground”. The “antenna feed” and the “antenna ground” may be disposed on the PCB. Thus, a length of the PCB may be similar to a length of the slot.

In such scenarios, the length of the slot may have an impact on a center frequency and a width of the slot may have an impact on the antenna performance. For example, the performance of the antenna may be reduced when the slot width is reduced below 2.5 mm. Therefore, the electronic devices may define a slot width of about 2.5 mm on the conductive housing, for instance, for WLAN applications to meet a target performance. However, the slot width of around 2.5 mm may be visible on the laptop computer and may affect a physical appearance of the electronic device. For an industrial point of view, a minimum or reduced slot width may enhance an appearance of the electronic device.

Examples described herein provides an electronic device including a conductive housing (e.g., a metal housing). The conductive housing may include a first slot, a second slot, and a bridge portion (e.g., a conductive line) to separate the first slot and the second slot. Further, the electronic device may include a PCB disposed on the conductive housing via a first surface of the PCB, Furthermore, the electronic device may include an antenna trace formed on a second surface of the PCB. The antenna trace may extend from the first slot to the second slot via the bridge portion. Also, the electronic device may include an antenna feed electrically connected to the antenna trace in the first slot and an antenna ground electrically connected to the antenna trace in the second slot.

The first slot and the second slot may have a combined length of around one wavelength of the application frequency. In this example, the bridge portion facilitates the first slot and the second slot to resonate at different resonant frequencies of a frequency band. Examples described herein reduces the slot width, for instance, from about 2.5 mm to about 1 mm (e.g., which is about 70% size reduction of the slot width) with the antenna radiation efficiency of about 50%. Thus, examples described herein enhances the appearance of the electronic devices.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

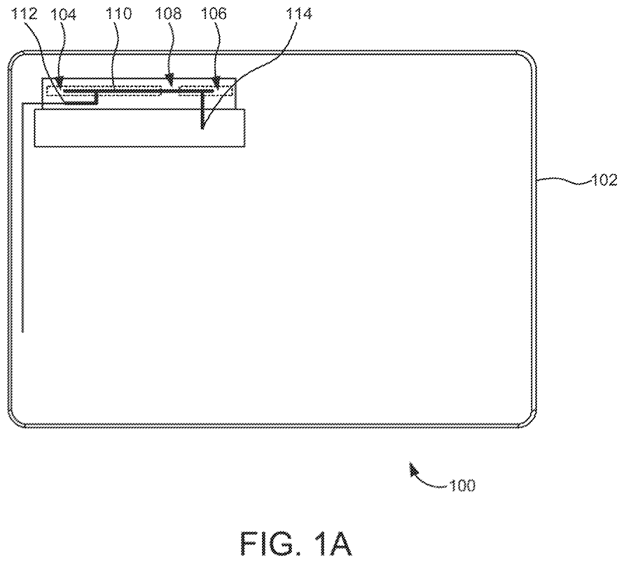

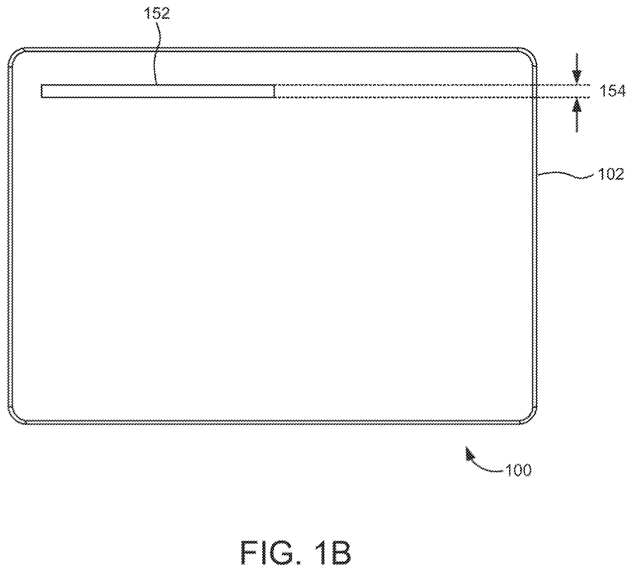

Turning now to the figures, FIG. 1A is a schematic diagram of an example electronic device 100, including an antenna layout 110 disposed across a first slot 104, a second slot 106, and a bridge portion 108. Example electronic device 100 is a laptop computer, a notebook computer, a tablet computer, a smartphone, or the like. As shown in FIG. 1A, electronic device 100 includes conductive housing 102. Conductive housing 102 may be formed from a metal such as an aluminum alloy, a magnesium alloy, zinc alloy, or the like. Example conductive housing 102 is a display housing (e.g., a rear housing) to house a display panel.

In an example, conductive housing 102 includes first slot 104, second slot 106, and bridge portion 108 to separate first slot 104 and second slot 106. As used herein, bridge portion 108 is a conductive structure that divides an elongated opening in conductive housing 102 into first slot 104 and second slot 106. Bridge portion 108 is formed between a short side of first slot 104 and second slot 106. In an example, bridge portion 108 is formed as a single-piece structure with conductive housing 102 between first slot 104 and second slot 106. In this example, first slot 104 is etched on conductive housing 102. Further, second slot 106 is etched on conductive housing 102 adjacent to first slot 104 and is separated from first slot 104 by bridge portion 108 etched in between first slot 104 and second slot 106. In another example, bridge portion 108 is electrically connected to conductive housing 102 across the elongated opening to divide the elongated opening into first slot 104 and second slot 106. Bridge portion 108 may isolate first slot 104 and second slot 106 to prevent any interference of signals communicated via first slot 104 and second slot 106.

In some examples, conductive housing 102 includes a display region and a non-display region. The non-display region may be covered by a bezel of conductive housing 102 or a display layer (e.g., a front glass) of the display panel. In this example, first slot 104, second slot 106, and bridge portion 108 is formed in an upper non-display region that abuts a top side of the display region as shown in FIG. 1A. In another example, first slot 104, second slot 106, and bridge portion 108 can be formed in a lower non-display region that abuts a bottom side of the display region. In other examples, first slot 104, second slot 106, and bridge portion 108 can also be formed in the display region behind the display panel.

Further, electronic device 100 includes antenna layout 110 disposed across first slot 104, second slot 106, and bridge portion 108 as shown in FIG. 1A. In this example, first slot 104, second slot 106, and antenna layout 110 may form a slot antenna. The slot antenna may emit or receive radio waves. Antenna layout 110 may be used with a transmitter/receiver of a radio device. The radio device including both the transmitter and the receiver may be termed as a transceiver. Antenna resonating elements for antenna layout 110 may be formed from first slot 104 and second slot 106 in conductive housing 102. First slot 104 and second slot 106 may be filled with air or with a solid dielectric such as plastic, epoxy, or the like. Each of the first slot 104 and second slot 106 may have a length that is longer than a width. First slot 104 and second slot 106 may serve as antenna resonating elements for antenna layout 110, and conductive housing 102 may serve as a ground plane for antenna layout 110.

In an example, antenna layout 110 includes a dielectric layer and an antenna layer (e.g., a conductive material). In this example, bridge portion 108, a portion of the dielectric layer below bridge portion 108, and a portion of the antenna layer below bridge portion 108 are to operate as a microstrip line. As used herein, the microstrip line is an electrical transmission line which can be fabricated with a technology where a conductor (e.g., the antenna layer) is separated from a ground plane (e.g., bridge portion 108) by the dielectric layer. The microstrip line can be used to convey microwave-frequency signals. A characteristic impedance of the microstrip line is a function of a width and a thickness of the conductor and a distance between the conductor and bridge portion 108.

In an example, first slot 104 and second slot 106 are closed slots. Further, bridge portion 108 may have a width in a range of 2 mm to 10 mm between first slot 104 and second slot 106, for instance, in 2.4 GHz, 5 GHz, and 6 GHz frequency bands. Bridge portion 108 may be made up of a metal as that of conductive housing 102, for instance.

Further, electronic device 100 includes an antenna feed 112 and an antenna ground 114. In an example, antenna feed 112 is coupled to antenna layout 110 in first slot 104 and antenna ground 114 is coupled to antenna layout 110 in second slot 106. For example, antenna feed 112 is to supply a radio frequency input from a feedline (e.g., a coaxial cable). Antenna feed 112 may be a location on antenna layout 110, where the feedline from antenna feed 112 is connected. As used herein, the feedline is a transmission line connected between antenna layout 110 and the transceiver. During operation, antenna feed 112 may convey radio-frequency signals between antenna layout 110 and the transceiver.

Antenna ground 114 may be a location on antenna layout 110, where antenna layout 110 is connected to a grounding element. The grounding element may be a flat horizontal conducting surface that serves as part of antenna layout 110, to reflect the radio waves from the other antenna elements. An example grounding element is formed from a printed circuit board (PCB), a planar metal structure, conductive electrical components, conductive housing 102, or any combination thereof.

During operation, antenna layout 110 may couple electromagnetic energy to first slot 104, second slot 106, and bridge portion 108. In this example, first slot 104 resonates at a first resonant frequency in a frequency band and second slot 106 resonates at a second resonant frequency in the frequency band. The second resonant frequency is different from the first resonant frequency. Further, the first slot and the second slot may include a combined length of about one wavelength of a frequency in a frequency band of interest to meet a target performance.

FIG. 1B is a schematic diagram of example electronic device 100 of FIG. 1A, depicting additional features. For example, similarly named elements of FIG. 1B may be similar in structure and/or function to elements described with respect to FIG. 1A. Particularly, FIG. 1B depicts a rear view of electronic device 100 of FIG. 1A. As shown in FIG. 1B, electronic device 100 includes a non-conductive cover portion 152 to cover or fill first slot 104 and second slot 106 of FIG. 1A. Non-conductive cover portion 152 may be formed using a material such as rubber, plastic, or the like. First slot 104 and second slot 106 may have a width 154 of about 1 mm, for instance. Thus, examples described herein may utilize first slot 104, second slot 106, and bridge portion 108 to reduce a width of slots for slot antennas without compromising on the antenna efficiency.

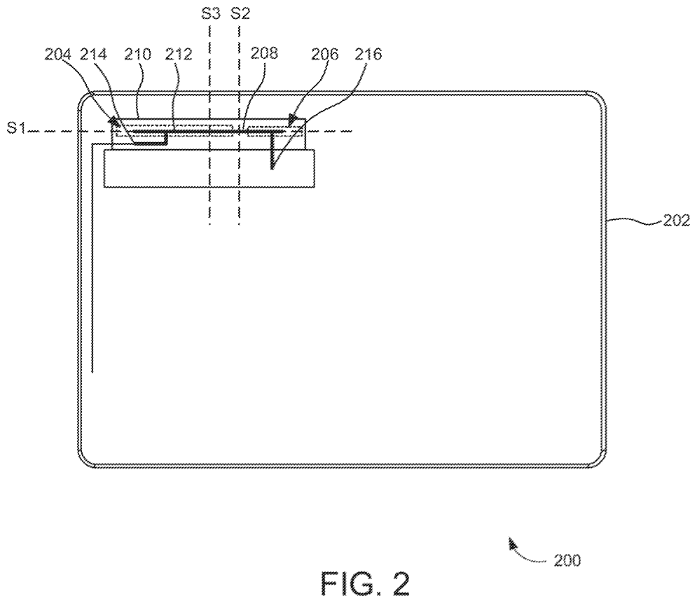

FIG. 2 is a schematic diagram of another example electronic device 200, depicting an antenna trace 212 disposed on a PCB 210 and extended from a first slot 204 to a second slot 206 via a bridge portion 208. As shown in FIG. 2, electronic device 200 includes conductive housing 202. In an example, conductive housing 202 includes first slot 204, second slot 206, and bridge portion 208 to separate first slot 204 and second slot 206. For example, first slot 204 includes a first length and second slot 206 includes a second length different from the first length. The second length may be less than the first length.

Further, electronic device 200 incudes PCB 210 disposed on conductive housing 202 via a first surface of PCB 210. For example, PCB 210 is a laminated sandwich structure of conductive and insulating layers. Furthermore, electronic device 200 includes antenna trace 212 formed on a second surface of PCB 210. Antenna trace 212 may extend from first slot 204 to second slot 206 via bridge portion 208.

In an example, antenna trace 212 is a surface mount antenna that can be disposed or formed on PCB 210. In another example, antenna trace 212 is integrated in PCB 210. In yet another example, antenna trace 212 can be a PCB antenna that includes another PCB and a trace drawn onto the other PCB. Example antenna trace 212 can be a PCB trace antenna, a patch antenna, a chip antenna, a dipole antenna, a monopole antenna, a loop antenna, microstrip antenna, or any other type of antenna suitable for transmission of radio frequency signals. An example PCB trace antenna may include a trace laminated on a surface of PCB 210 or, in some examples, traces that can occupy several layers of a multilayer PCB, and the traces on each layer may be interconnected.

Furthermore, electronic device 200 includes an antenna feed 214 electrically connected to antenna trace 212 in first slot 204 and an antenna ground 216 electrically connected to antenna trace 212 in second slot 206. Bridge portion 208, a portion of PCB 210 below bridge portion 208, and a portion of antenna trace 212 below bridge portion 208 may form a microstrip line to provide mutual electrical field of conductive housing 202 to antenna trace 212. In an example, bridge portion 208 controls an impedance of antenna trace 212. The impedance may relate to a voltage and current at an input to antenna trace 212.

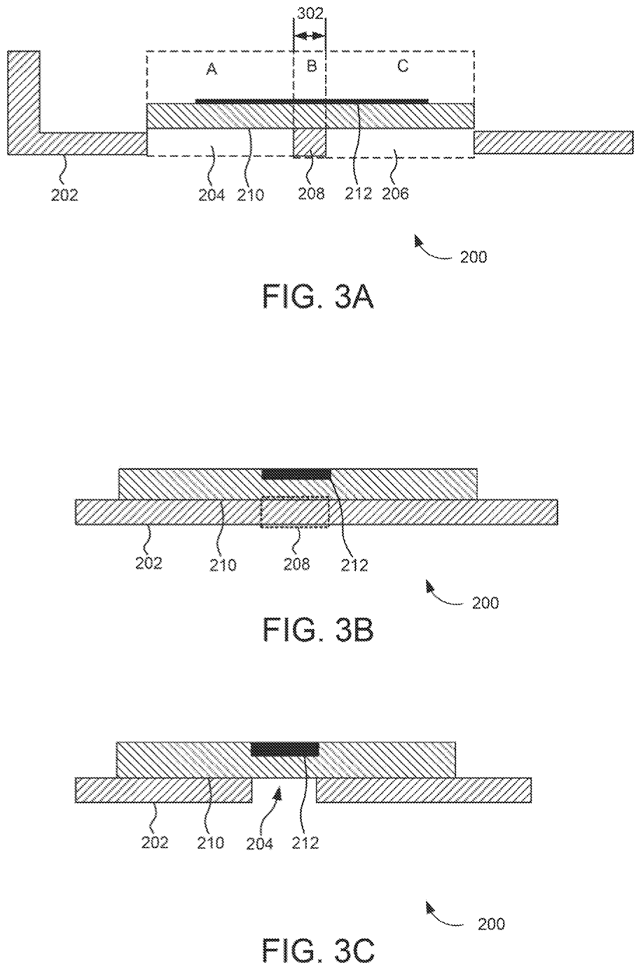

FIG. 3A is a cross-sectional front view (e.g., S1 as shown in FIG. 2) of a portion of example electronic device 200 of FIG. 2, depicting additional features. For example, similarly named elements of FIG. 3A may be similar in structure and/or function to elements described with respect to FIG. 2. As shown in FIG. 3A, antenna trace 212 is disposed in three different areas (e.g., A, B, and C). For example, area “A” (e.g., corresponding to first slot 204) includes a first part of antenna trace 212 and an antenna feed (i.e., antenna feed 214 as shown in FIG. 2). Further, area “B” (e.g., corresponding to bridge portion 208) may include a second part of antenna trace 212. The second part of antenna trace 212, medium from PCB 210, and bridge portion 208 in area B may provide a microstrip line structure. Further, a width 302 of bridge portion 208 may facilitate in current phase and impedance adjustment as described in FIGS. 3B and 3C.

Furthermore, area “C” (e.g., corresponding to second slot 206) may include a third part of antenna layout 212. Antenna layout 212 may be short to the ground in area “C”. Thus, antenna trace 212 continues from area “A” to area “C” by a conductive material. Antenna trace 212 may include three different couplings. For example, antenna trace 212 couples an electromagnetic energy to first slot 204 in area “A”, to bridge portion 208 in area “B”, and to second slot 206 in area “C”.

FIG. 3B is a cross-sectional side view (e.g., S2 as shown in FIG. 2) of example electronic device 200 of FIG. 2, depicting a microstrip line structure. In the example shown in FIG. 3B, a part of antenna trace 212, PCB 210, and bridge portion 208 may work as the microstrip line structure to provide a mutual electrical field of conductive housing 202 to antenna trace 212. Further, a distance between antenna trace 212 and bridge portion 208, a shape of antenna trace 212 below bridge portion 208, and a material between bridge portion 208 and antenna trace 212 are to define a mutual electric field and an impedance of antenna trace 212.

FIG. 3C is another cross-sectional side view (e.g., S3 as shown in FIG. 2) of example electronic device 200 of FIG. 2, depicting first slot 204 under antenna trace 212. In the example shown in FIG. 3C, first slot 204 is under antenna trace 212 and passes electric field through first slot 204. Similarly, second slot 206 may be under antenna trace 212 and may pass electric field through second slot 206.

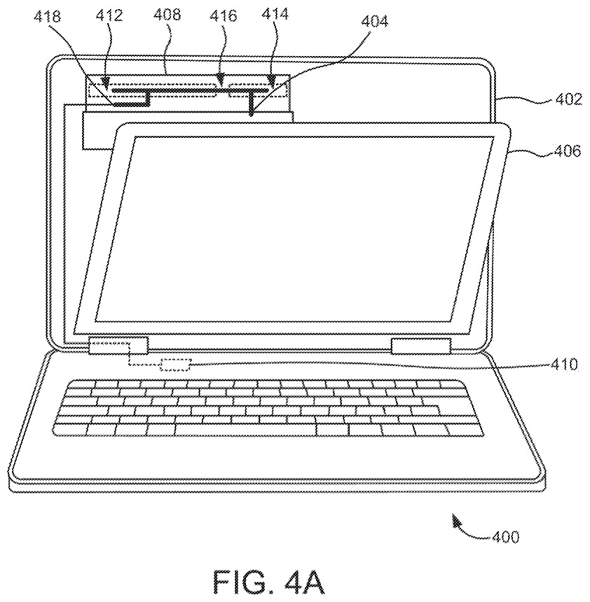

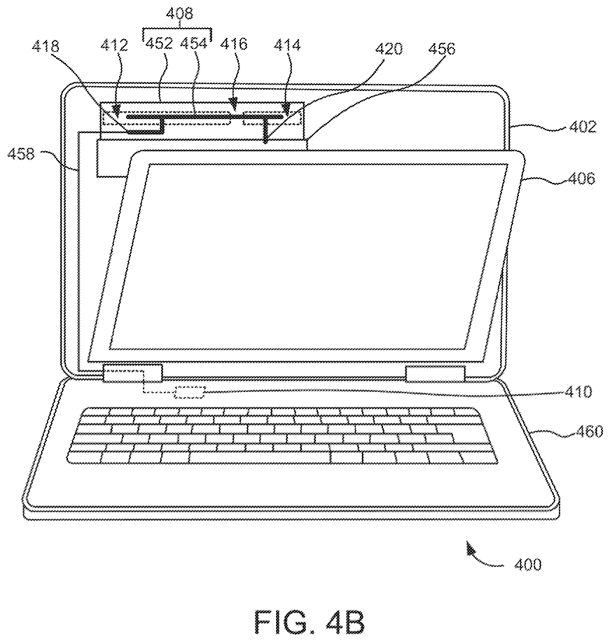

FIG. 4A is a schematic diagram of an example electronic device 400, depicting a PCB antenna 408 to couple an electromagnetic energy to a first closed slot 412, a second closed slot 414, and a bridge portion 416. As shown in FIG. 4A, electronic device 400 includes a conductive housing 402 that forms a ground plane. Further, electronic device 400 includes a display panel 406 disposed in conductive housing 402. Furthermore, electronic device 400 includes PCB antenna 408 abutting a side of display panel 406. Also, electronic device 400 includes first closed slot 412 in conductive housing 402 that forms a first slot antenna resonating element for PCB antenna 408. Further, electronic device 400 includes second closed slot 414 in conductive housing 402 that forms a second slot antenna resonating element for PCB antenna 408.

Further, electronic device 400 includes bridge portion 416 of conductive housing 402 to separate first closed slot 412 and second closed slot 414. For example, first closed slot 412 and second closed slot 414 are rectangular slots. First closed slot 412 is defined in series to second closed slot 414. In this example, bridge portion 416 of conductive housing 402 is formed between a short side of first closed slot 412 and second closed slot 414. Further, first closed slot 412 may include a length in a range of 45 mm to 60 mm, second closed slot 414 may include a length in a range of 25 mm to 40 mm, and bridge portion 416 may include a width in a range of 2 mm to 10 mm for 2.4 GHz, 5 GHz, and 6 GHz applications. In an example, PCB antenna 408 is to couple an electromagnetic energy to first closed slot 412, second closed slot 414, and bridge portion 416.

Further as shown in FIG. 4A, electronic device 400 includes an antenna feed 418 to couple the first slot antenna resonating element to a transceiver 410. Furthermore, electronic device 400 includes an antenna ground 404 to ground the second slot antenna resonating element. In an example, the first slot antenna resonating element in combination with bridge portion 416 is to resonate at a first resonant frequency in a frequency band and the second slot antenna resonating element in combination with bridge portion 416 is to resonate at a second resonant frequency in the frequency band. The second resonant frequency may be different from the first resonant frequency.

FIG. 4B is a schematic diagram of example electronic device 400 of FIG. 4A, depicting additional features. For example, similarly named elements of FIG. 4B may be similar in structure and/or function to elements described with respect to FIG. 4A. As shown in FIG. 4B, electronic device 400 may include a base housing 460 and conductive housing 402 (i.e., a display housing) detachably, rotatably, or twistably connected to base housing 460. Base housing 460 may house a keyboard, a battery, a touchpad, and the like, and conductive housing 402 may house display panel 406. In other examples, conductive housing 402 and base housing 460 may house other components depending on the functions of electronic device 400.

Further, PCB antenna 408 includes a PCB 452 having a first surface and a second surface. PCB 452 may be disposed on conductive housing 402 via the first surface. Further, PCB antenna 408 includes an antenna trace 454 formed on the second surface of PCB 452. Further, antenna feed 418 may couple the first slot antenna resonating element to transceiver 410 via a feedline 458 (e.g., a coaxial cable).

As shown in FIG. 4B, electronic device 400 may include a grounding element 456 coupled to conductive housing 402 to ground the second slot antenna resonating element via antenna ground 404. For example, grounding element 456 is a conductive foil. For example, conductive housing 402 and grounding element 456 are shorted together to form a ground plane in electronic device 400 or to expand a ground plane structure that is formed from a planar circuit structure such as PCB 452 used in forming antenna structures for electronic device 400. In an example shown in FIGS. 4A and 4B, bridge portion 416, a portion of PCB 452 below bridge portion 416, and a portion of antenna trace 454 below bridge portion 416 are to form a microstrip line to provide mutual electrical field of conductive housing 402 to PCB antenna 408.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

1. An electronic device comprising:
a conductive housing comprising:
a first slot;
a second slot; and
a bridge portion to separate the first slot and the second slot;
an antenna layout comprising a single microstrip disposed across the first slot, the second slot, and the bridge portion;
an antenna feed coupled to the antenna layout in the first slot; and
an antenna ground coupled to the antenna layout in the second slot.

2. The electronic device of claim 1, wherein the first slot and the second slot are closed slots.

3. The electronic device of claim 1, wherein the bridge portion is to have a width in a range of 2 mm to 10 mm between the first slot and the second slot.

4. The electronic device of claim 1, wherein the first slot is to resonate at a first resonant frequency in a frequency band and the second slot is to resonate at a second resonant frequency in the frequency band, wherein the second resonant frequency is different from the first resonant frequency.

5. The electronic device of claim 1, wherein the first slot and the second slot include a combined length of about one wavelength of a frequency in a frequency band of interest.

6. The electronic device of claim 1, wherein the antenna layout comprises a dielectric layer and an antenna layer, and wherein the bridge portion, a portion of the dielectric layer below the bridge portion, and a portion of the antenna layer below the bridge portion are to operate as a microstrip line.

7. The electronic device of claim 1, further comprising:
a non-conductive cover portion to cover the first slot and the second slot.

8. An electronic device comprising:
a conductive housing comprising:
a first slot;
a second slot; and
a bridge portion to separate the first slot and the second slot;
a printed circuit board (PCB) disposed on the conductive housing via a first surface of the PCB;
an antenna trace comprising a single microstrip formed on a second surface of the PCB, wherein the antenna trace is to extend from the first slot to the second slot via the bridge portion;
an antenna feed electrically connected to the antenna trace in the first slot; and
an antenna ground electrically connected to the antenna trace in the second slot.

9. The electronic device of claim 8, wherein the bridge portion, a portion of the PCB below the bridge portion, and a portion of the antenna trace below the bridge portion are to form a microstrip line to provide mutual electrical field of the conductive housing to the antenna trace.

10. The electronic device of claim 8, wherein the first slot is to include a first length and the second slot is to include a second length different from the first length.

11. The electronic device of claim 10, wherein the second length is less than the first length.

12. The electronic device of claim 8, wherein the bridge portion is to control an impedance of the antenna trace.

13. The electronic device of claim 8, wherein a distance between the antenna trace and the bridge portion, a shape of the antenna trace below the bridge portion, and a material between the bridge portion and the antenna trace are to define a mutual electric field and an impedance of the antenna trace.

14. An electronic device comprising:
a conductive housing forming a ground plane;
a display panel disposed in the conductive housing;
a printed circuit board (PCB) antenna comprising a single microstrip abutting a side of the display panel;
a transceiver;
a first closed slot in the conductive housing that forms a first slot antenna resonating element for the PCB antenna;
a second closed slot in the conductive housing that forms a second slot antenna resonating element for the PCB antenna;
a bridge portion of the conductive housing to separate the first closed slot and the second closed slot, wherein the PCB antenna is to couple an electromagnetic energy to the first closed slot, the second closed slot, and the bridge portion;
an antenna feed to couple the first slot antenna resonating element to the transceiver; and
an antenna ground to ground the second slot antenna resonating element.

15. The electronic device of claim 14, wherein the PCB antenna comprises:
a PCB having a first surface and a second surface, wherein the PCB is disposed on the conductive housing via the first surface; and
an antenna trace formed on the second surface of the PCB.

16. The electronic device of claim 15, wherein the bridge portion, a portion of the PCB below the bridge portion, and a portion of the antenna trace below the bridge portion are to form a microstrip line to provide mutual electrical field of the conductive housing to the PCB antenna.

17. The electronic device of claim 14, further comprising:
a grounding element coupled to the conductive housing to ground the second slot antenna resonating element via the antenna ground, wherein the grounding element is a conductive foil.

18. The electronic device of claim 14, wherein the bridge portion of the conductive housing is formed between a short side of the first closed slot and the second closed slot.

19. The electronic device of claim 14, wherein the first slot antenna resonating element in combination with the bridge portion is to resonate at a first resonant frequency in a frequency band and the second slot antenna resonating element in combination with the bridge portion is to resonate at a second resonant frequency in the frequency band, wherein the second resonant frequency is different from the first resonant frequency.

20. The electronic device of claim 14, wherein the first closed slot is to include a length in a range of 45 mm to 60 mm, the second closed slot is to include a length in a range of 25 mm to 40 mm, and wherein the bridge portion is to include a width in a range of 2 mm to 10 mm for 2.4 GHz, 5 GHz, and 6 GHz applications.
